(19) United States
(12) Patent Application Publication
(10) Pub. No.: US 2010/0022184 A1
(43) Pub. Date: Jan. 28, 2010

(54) SYSTEMS AND METHODS FOR SELECTIVE RELAYING IN WIRELESS NETWORKS

(75) Inventors: Ahmad Khoshnevis, Portland, OR (US); John M. Kowalski, Camas, WA (US); Kenneth J. Park, Cathlamet, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/177,827

(22) Filed: Jul. 22, 2008

(51) Int. Cl. H04B 7/14

(52) U.S. Cl. 455/7; 455/561; 370/315

(57) ABSTRACT

A method for selective transmission by a relay node in a wireless communications system is described. A signal is received. Channel quality information is received. A threshold value is determined. The channel quality information is compared to the threshold value. The signal is transmitted if the channel quality information is above the threshold value.

### TECHNICAL FIELD

The present disclosure relates generally to communications and wireless communications systems. More specifically, the present disclosure relates to systems and methods for selective relaying in wireless networks.

### BACKGROUND

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. The 3GPP may define specifications for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN). In 3GPP LTE a mobile terminal or device is called a “user equipment” (UE) and a relaying station is called a “relay node.” A base station be may referred to as an evolved NodeB (eNB).

The use of relay nodes has been adopted for use in the Institute of Electrical and Electronics Engineers (IEEE) 802.16m and the Worldwide Interoperability for Microwave Access (WiMax) technologies.

Resource scheduling means the eNB allocates the modulation schemes, coding rates, time slot and subcarrier frequencies to optimize the downlink and uplink transmissions for each UE. Because of varying quality of service (QoS) and security requirements, the retransmission of signals may be prevented because these signals may cause interference, consume unnecessary power, and lower the capacity of the network.

Therefore, improvements in wireless networks can be obtained by reducing the communication overhead without causing degradation in the system performance.

### BRIEF DESCRIPTION OF THE DRAWINGS

FIG. 1 illustrates a wireless communication system in which the present systems and methods may be practiced;

FIG. 2 is a block diagram illustrating a base station for use in the present systems and methods;

FIG. 3 is a block diagram illustrating a relay node for use in the present systems and methods;

FIG. 4 is a block diagram illustrating a wireless communication system with multiple UEs, a relay node, and a base station during a first transmission at time t;

FIG. 5 is a block diagram illustrating a wireless communication system with multiple UEs, a relay node, and a base station during a second transmission at time t+1;

FIG. 6 is a block diagram illustrating a wireless communication system with multiple UEs, a relay node, and a base station during a second transmission at time t+1;

FIG. 7 is a flow diagram illustrating a scheduling table method for selective relaying;

FIG. 8 is a flow diagram illustrating a threshold method for selective relaying;

FIG. 9 is a flow diagram illustrating an additional scheduling table method for selective relaying;

FIG. 10 is a flow diagram illustrating an additional threshold method for selective relaying;

FIG. 11 is a flow diagram illustrating a method for selective relaying of an emergency signal;

FIG. 12 is a flow diagram illustrating a method for signal triggered selective relaying;

FIG. 13 is a block diagram of a base station in accordance with one configuration of the described systems and methods; and

FIG. 14 is a block diagram of a relay node in accordance with one configuration of the described systems and methods.

### DETAILED DESCRIPTION

A method for selective transmission by a relay node in a wireless communications system is described. A signal is received. Channel quality information is received. A threshold value is determined. The channel quality information is compared to the threshold value. The signal is transmitted if the channel quality information is above the threshold value.

Channel quality information may be based on a reference signal from a user equipment (UE), or it may be based on a reference signal from a base station.

A scheduling table may be generated using the channel quality information. The scheduling table may be received from a base station.

The signal may be automatically transmitted if the signal is an emergency signal. Automatically transmitting the signal may include overriding preexisting masking/forwarding rules and disregarding the status of the network.

The signal may be transmitted if the relay node receives a negative acknowledgment (NAK) corresponding to the signal from the base station. The signal may be retransmitted if the relay node receives a negative acknowledgment (NAK) corresponding to the signal from the UE.

The systems and methods herein may be implemented to support an Institute of Electrical and Electronics Engineers (IEEE) 802.16 standard. The systems and methods herein may also be implemented to support the next generation of standards, in particular LTE-Advanced, the improved version of LTE.

A relay node for selective transmission in a wireless system is also disclosed. The relay node includes a processor and memory in electronic communication with the processor. Executable instructions are stored in the memory. A signal is received. Channel quality information is received. A threshold value is determined. The channel quality information is compared to the threshold value. The signal is transmitted if the channel quality information is above the threshold value.

A base station for directing a relay node regarding selective transmission in a wireless communication system is also disclosed. The base station includes a processor and memory in electronic communication with the processor. Executable instructions are stored in the memory. Channel quality information is determined for multiple channels. Instructions are transmitted to a relay node to transmit certain signals the relay node has received. Instructions are also transmitted to a relay node not to transmit other signals the relay node has received. Not all signals received by the relay node are transmitted by the relay node.

A computer readable medium is also disclosed. The computer-readable medium comprises executable instructions. A signal is received. Channel quality information is received. A threshold value is determined. The channel quality information is compared to the threshold value. The signal is transmitted if the channel quality information is above the threshold value.

The present systems and methods may be implemented and used for uplink communications and/or for downlink communications. The various configurations herein are only meant to illustrate possible examples of how the present systems and methods may be implemented and are not meant to limit the disclosure to being used with only the uplink or only the downlink. The systems and methods herein may be used with downlink communications, with uplink communications, and with both downlink and uplink communications.

Generally, there is a source, a relay node and a destination. In the uplink, the source is a UE and the destination is a base station. In the downlink the source is a base station and a UE is the destination. The role of the relay node is to assist the transmission from source to destination. The relay node helps the transmission of information from source to destination by retransmitting the source's signal to the destination.

However, such assistance is not always needed. This disclosure introduces the idea of “selective relaying” and provides methods for implementing and achieving it. The basic idea is that if the destination is able to correctly receive the source signal, then there is no need for retransmission by a relay node. In this regard, different methods are introduced for implementing this technique. One method uses reference signals. A source sends a reference signal; a destination receives it. Using the reference signal, the destination measures the channel quality. If the channel quality is above a certain threshold, the destination concludes that it is capable of correctly receiving source's signal. Therefore, it asks the relay node not to retransmit those signals.

In another method reference signals may not be used. Each transmission from a source to a destination is followed by a control signal. If the control signal is an ACK (acknowledgement), it indicates the correct reception of the signal by the destination. When a NAK (negative acknowledgement) is being sent, it indicates that the destination was unable to correctly receive the source's signal. The relay node can overhear the transmission of ACK/NAK. If the relay node hears an ACK, then there is no need for retransmission. If the relay node overhears a NAK, then it retransmits the source's signal.

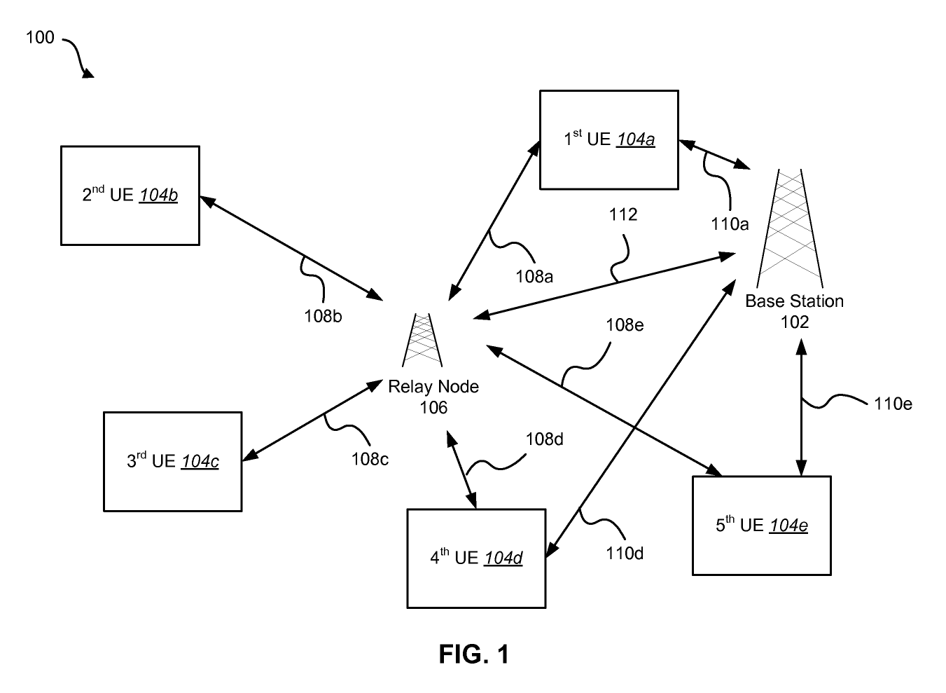

FIG. 1 illustrates a wireless communication system 100 in which the present systems and methods may be practiced. In a communications system 100, transmission signals 110 may be sent from a mobile device 104 to a base station 102 and from a base station 102 to a mobile device 104. Communications from the mobile device 104 to the base station 102 may be referred to as uplink communications. Similarly, communications from the base station 102 to the mobile device 104 may be referred to as downlink communications. Although not shown, a wireless communication system 100 may include more than one base station 102 and more than one relay node 106. Additionally, a wireless communication system 100 may include more than the five UEs 104 shown in FIG. 1.

The present systems and methods may operate independent of the physical layer access technology used by the wireless network. Examples of access technologies include orthogonal frequency division multiplexing (OFDM), frequency division multiple access (FDMA), and code division multiple access (CDMA). In addition, the present systems and methods may operate independent of whether the system is full or half duplex.

The present systems and methods described herein relate to 3GPP LTE systems. However, the present systems and methods may be utilized for other communication systems such as IEEE 802.16(e, m), WiMax systems, and other systems where the scheduling of users is applicable.

The mobile station may be referred to as user equipment (UE) 104. A base station 102 may be in wireless communication with one or more UEs 104 (which may also be referred to as mobile stations, user devices, communications devices, subscriber units, access terminals, terminals, etc.). The base station 102 may be a unit adapted to transmit to and receive data from cells.

In one example, the base station 102 handles the actual communication across a radio interface, covering a specific geographical area in the vicinity of the base station 102, which is referred to as a cell. Depending on sectoring, one or more cells may be served by the base station 102, and accordingly the base station 102 may support one or more UEs 104 depending on where the UEs 104 are located. In one configuration, the base station 102 provides a 3GPP (Release 8) Long Term Evolution (LTE) air interface and performs radio resource management for the communication system 100.

The base station 102 may be in electronic communication with one or more UEs 104. A first UE 104a, a second UE 104b, a third UE 104c, a fourth UE 104d and a fifth UE 104e are shown in FIG. 1. The base station 102 may transmit data to the UEs 104 and receive data from the UEs 104 over a radio frequency (RF) communication channel 110.

A relay node 106 is also shown in FIG. 1. A relay node 106 may receive transmissions from one or more UE's 104, a base station 102, or both over an RF communication channel. The communication link between a relay node 106 and a base station 102 may be a wired connection as well. The relay node 106 may retransmit or repeat some or all of the received transmissions. The relay node 106 may transmit data to the UEs 104 and receive data from the UEs 104 over an RF communication channel 108. The relay node 106 may also transmit data to the base station 102 and receive data from the base station 102 over an RF communication channel 112. In uplink and downlink communications, the relay node 106 may receive signals that are directed from UEs 104 to the base station 102 and signals that are directed from the base station 102 to UEs 104. The relay node 106 may retransmit the received signals towards the desired destination. A relay node 106 may have different modes of operation. For example, a relay node 106 may repeat every received analog signal. Alternatively, a relay node 106 may perform signal processing on the received signals before retransmission.

The signals transmitted by a UE 104 may include requests for data. The signals transmitted by the base station 102 may be data requested by a particular UE 104 such as downloaded internet data. Alternatively, the signals transmitted by the base station 102 and UEs 104 may include data for maintaining the wireless communication system 100. For example, the base station 102 may transmit reference signals to the UEs 104 requesting channel estimation and the UEs 104 may return channel estimation values to the base station 102. Examples of possible reference signals include pilots or beacons which may be single tone signals with a known amplitude and frequency. Another example may be a reference signal used in current LTE systems, which is a known (by transmitter and receiver) sequence of symbols used for estimating the channel. A further example of a reference signal may be Zadoff-Chu sequences as described in 3GPP TS 36.211 V8.2.0 (2008-03).

A scheduler on the base station 102 may determine the service parameters, such as the coding and modulation scheme of a UE 104 before it is served. The scheduler may assign one or more UEs 104 to each communication channel. To perform this task, the base station 102 may need channel quality information of all the UEs 104 over the whole or a portion of the frequency band.

The data transmissions from the base station 102 to the UEs 104 and from the UEs 104 to the base station 102 may not always be successfully received by the intended recipients. A data transmission may be successfully received by a relay node 106 that has not been successfully received by the intended recipient. The relay node 106 may thus retransmit some received data transmissions. However, not all of the received signals need to be retransmitted by the relay node 106. Some of the signals may have been successfully received by the intended recipient and hence do not need to be retransmitted. Furthermore, the unnecessary retransmission of signals consumes time, power, and bandwidth and may further cause interference to other concurrent transmissions. In addition, upon detection of malicious users, the relay node 106 and base station 102 may directly mask the malicious users, which in this case mean users who are attempting to consume more bandwidth than they were entitled to do so or may imply deliberate interferers. This masking therefore would result in increasing the security of the system.

The relay node 106 may select or mask the signals that do not need to be retransmitted. The selection or masking operation may be performed at the relay node 106 in the radio and intermediate frequencies via band-pass filtering. The selection or masking operation may also be performed in the baseband via digital filtering or other signal processing methods.

A UE 104 may be geographically located closer to either the base station 102 or a relay node 106. For example, the 1^{st} UE 104a of FIG. 1 may be geographically closer to the base station 102 than to the relay node 106. In contrast, the 3^{rd} UE 104c may be located much closer to the relay node 106 than to the base station 102. Similarly, in a fading environment, the 1^{st} UE channel to the base station 102 may be better than the channel between the 1^{st} UE 104a and the relay node 106, meaning that the received power at the base station 102 is higher than the received power at the relay node 106.

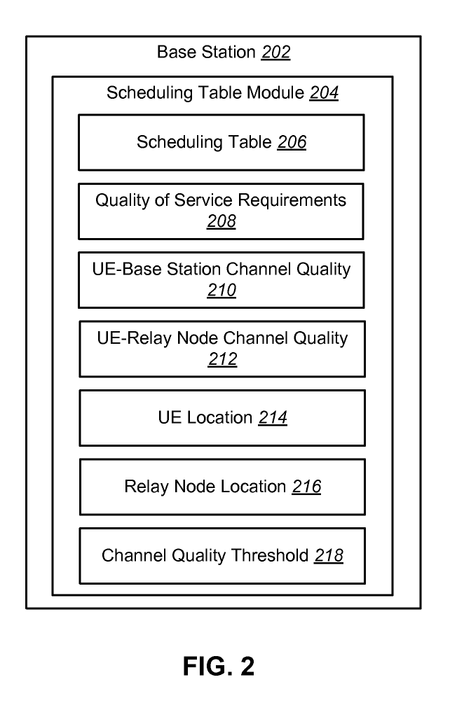

FIG. 2 is a block diagram illustrating a base station 202 for use in the present systems and methods. The base station 202 may include a scheduling table module 204. The scheduling table module 204 may generate a scheduling table 206. The scheduling table 206 may include instructions for a relay node 106. For example, the scheduling table 206 may instruct the relay node 106 as to which received transmissions are to be retransmitted. The scheduling table 206 may instruct the relay node 106 concerning transmissions that the relay node 106 has received from the UEs 104 and/or from the base station 202. The base station 202 may explicitly schedule UE 104 transmissions to be relayed and the scheduling table 206 may be broadcast to the relay nodes 106. The base station 202 may periodically generate and send a scheduling table 206 to a relay node 106. Alternatively, the base station 202 may send periodic updates to a scheduling table 206 located on the relay node 106. Note that the relay node 106 need not know that a received signal belongs to a specific UE 104. It is enough for the base station 202 to inform the relay node 106 of which signals in time and frequency are to be repeated, without specifying the identity of a UE 104.

The base station 202 may generate the scheduling table 206 based on channel quality measurements and other system requirements such as quality of service requirements 208. For example, the base station 202 may receive a reference signal from a UE 104. The base station 202 may use this reference signal to obtain a measurement of the UE-base station channel quality 210.

The relay node 106 may also receive a reference signal from the UE 104. The reference signal received by the relay node 106 may be the same reference signal that the UE 104 sent to the base station 202. Alternatively, the UE 104 may send a different reference signal to the relay node 106. The relay node 106 may use the received reference signal to obtain measurements of the UE-relay node channel quality 212. Alternatively, the relay node 106 may forward the received reference signal to the base station 202. The relay node 106 may then transmit the UE-relay node channel measurements to the base station 202. The base station 202 may have the ability to optimize the performance of the network and make decisions on behalf of the UEs 104 because the base station 202 has a full picture of the uplink channel qualities. The base station 202 may also have a full picture of the downlink channel qualities by receiving channel quality information in feedback from the UEs 104 and relay nodes 106.

The base station 202 may also generate the scheduling table 206 based on the relay node location 216 and/or the UE location 214 that is either sending a transmission to the base station 202 or is the intended recipient of a transmission from the base station 202. Because the performance of the wireless network with a relay node 106 may depend on the relative distance between a UE 104 and the relay node 106, the distance between the UE 104 and the base station 202, and the distance between the relay node 106 and the base station 202, the base station 202 may use this information to optimize the wireless network. The distances may be inferred from the channel quality measurements made by the base station 202 and the relay node 106.

The base station 202 may generate the scheduling table 206 by comparing the UE-base station channel quality 210 to a channel quality threshold 218. The channel quality threshold 218 may depend on the transmission parameters such as the transmission power. The channel quality threshold 218 may be calculated at the base station 202. Alternatively, the channel quality threshold 218 may be a predetermined value stored in a look-up table.

There are two paths available from the UE 104 to the base station 202: 1) UE 104 to base station 202 and 2) UE 104 to relay node 106 to base station 202. Each path can support a data rate which in turn depends on the channel quality corresponding to that path. For the first path, the channel quality is determined by the quality of the channel between the UE 104 and base station 202, and for the second path, the effective channel quality is determined by the UE 104 to relay node 106 and relay node 106 to base station 202 channels. The base station 202 needs to decide which path is to be used. For making the decision one way is to incorporate the overhead of using the relay node 106 and calculate the data rate achieved by each path, and then decide the path that yields higher throughput. Another way to make the decision is to avoid using the relay node 106 as much as possible (to prevent the overhead associated with the use of the relay node 106). In this case, the base station 202 needs to know whether the received signal from the UE 104 is decodable or not provided that the UE 104 is using its smallest coding rate and modulation order. The required power associated with the successful reception of the smallest coding rate and modulation order is considered to be the comparison threshold. If the channel quality is better than this threshold it means that if the UE 104 transmits at its smallest coding rate and modulation order, the base station 202 is capable of successfully decoding the received signal.

The relay node 106 may also receive a protocol message set that has been partitioned into messages, some of which are transmitted through the relay node 106 and some of which are not transmitted through the relay node 106. The relay node 106 may inhibit the retransmission of the protocol message set. For example, the relay node 106 may inhibit all messages unless they are required to be retransmitted; this behavior may be induced in response to a negative Acknowledgement (NAK) sent from the destination node. There are other message set partitions possible. For example, if one set of messages requires higher reliability of transmission than another set of messages.

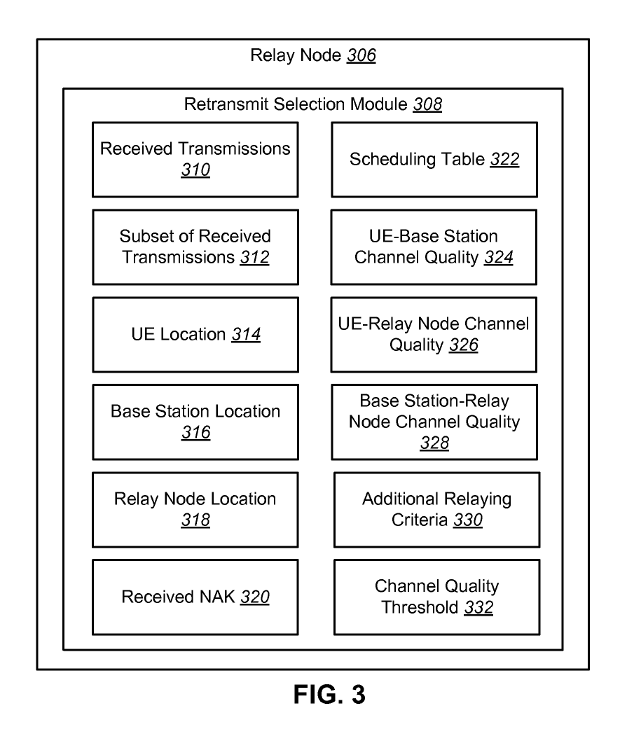

FIG. 3 is a block diagram illustrating a relay node 306 for use in the present systems and methods. A relay node 306 may be used in a communication system to reduce the error rate, to increase the coverage area, or to improve the throughput. A relay node 306 may not have unique information. Instead, a relay node 306 may simply retransmit received signal transmissions 310.

Multiple types or levels of relay nodes 306 may be available. A layer 1 relay node may amplify and retransmit a received analog signal without any processing. A layer 1 relay node may also be referred to as a repeater or a relay with an amplify-and-forward scheme. A layer 2 relay node may decode a received signal, re-encode the received signal, and retransmit the received signal. A layer 2 relay node may also be referred to as a regenerative relay or a relay with decode-and-forward functionality. A layer 3 relay node may be an intermediate base station 102 with the full functionality of a base station 102 to a proper subset of UEs 104 within the relay node's 306 vicinity. The present systems and methods may operate independent of the type of relay node 306.

The relay node 306 may include a retransmit selection module 308. The retransmit selection module 308 may determine which received signal transmissions 310 should be retransmitted. For example, the retransmit selection module 308 may determine a subset of received transmissions 312 that are to be retransmitted. The subset of received transmissions 312 may be defined in a scheduling table 322 that has been received from the base station 102. Alternatively, the retransmit selection module 308 may generate a scheduling table 322 to define the subset of received transmissions 312 that are to be retransmitted.

The retransmit selection module 308 on the relay node 306 may generate a scheduling table 322 based on channel quality measurements and other system requirements such as quality of service requirements 208. The relay node 306 may receive a reference signal from a UE 104. The relay node 306 may use this reference signal to obtain a measurement of the UE-relay node channel quality 326. The relay node 306 may also receive a measurement of the UE-base station channel quality 324 from the base station 102. As discussed above, the base station 102 may receive a reference signal from a UE 104 and may use this reference signal to obtain a measurement of the UE-base station channel quality 324.

The relay node 306 may also send a reference signal to or receive a reference signal from the base station 102. This reference signal may be used to determine the base station-relay node channel quality 328. The retransmit selection module 308 may then use the UE-base station channel quality 324, UE-relay node channel quality 326, and base station-relay node channel quality 328 to generate the scheduling table 322. For example, the retransmit selection module 308 may compare the measured channel qualities to a channel quality threshold 332 to determine whether received transmissions 310 should be retransmitted to their intended recipients.

The relay node 306 may also generate the scheduling table 322 based on the UE location 314 relative to the base station location 316 and the relay node location 318. The relative locations may be inferred from the channel quality measurements made by the base station 102 and the relay node 306.

The relay node 306 may use additional relaying criteria 330 for generating the scheduling table 322. For example, the various elements of a protocol may require a more reliable transmission. Control messages, data messages, and subsets of control message may all require different levels of reliable transmission. It may be more effective to retransmit signals from a relay node 306 or another base station 102 that correctly received a transmission from a UE 104 than to rely on retransmission from the UE 104. In this case, the base station 102 that retransmits the signal may function as a layer 3 relay node.

If the intended recipient of a signal does not correctly receive the signal, the intended recipient may send a negative acknowledgment (NAK) indicating that the signal was not properly received. The relay node 306 may receive the NAK 320 or overhear the NAK as it is sent to the original sender of the signal. Based on the received NAK 320, the relay node 306 may retransmit the corresponding signal to the intended recipient.

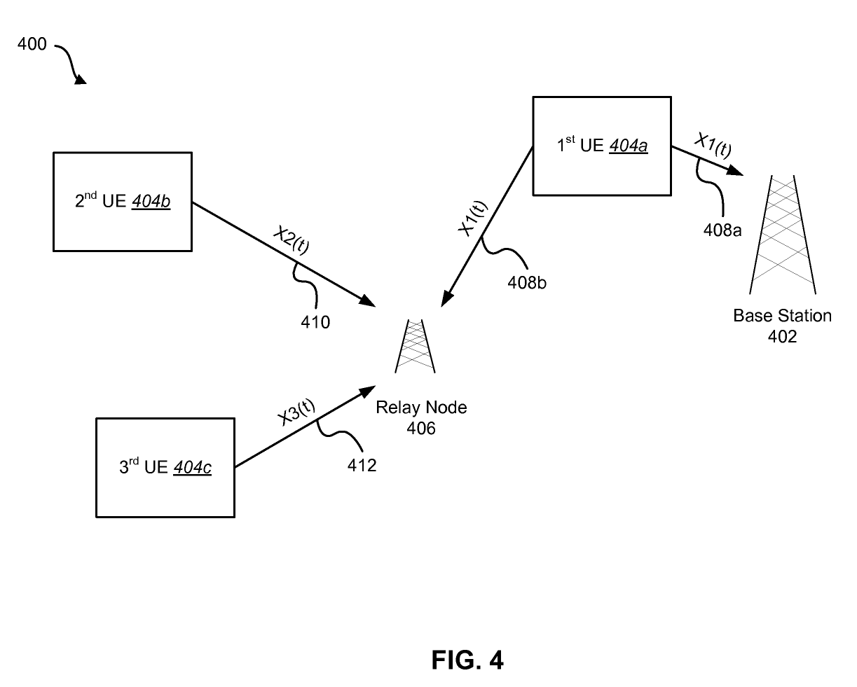

FIG. 4 is a block diagram illustrating a wireless communication system 400 with multiple UEs 404, a relay node 406, and a base station 402 during a first transmission at time t. The wireless communication system 400 may include a 1^{st} UE 404a, a 2^{nd} UE 404b, and a 3^{rd} UE 404c. The UEs 404 may be in electronic communication with a base station 402 and a relay node 406. In the first time slot at time t, each of the UEs 404 may transmit the signals Xi(t) 408, 410, 412 to the base station 402, where i=1, 2, or 3. Thus, the 1^{st} UE 404a may transmit X1(t) 408a, 408b, the 2^{nd} UE 404b may transmit X2(t) 410, and the 3^{rd} UE 404c may transmit X3(t) 412. Although the intended recipient is the base station 402, some or all of the signals may not be received by the base station 402 or may be incorrectly received. In addition, some or all of the signals may be received by the relay node 406.

In FIG. 4, X1(t) 408b, X2(t) 410, and X3(t) 412 are all received correctly by the relay node 406. Only X1(t) 408a is received correctly by the base station 402. There may thus be a need for the 2^{nd} UE 404b to retransmit X2(t) 410 and the 3^{rd} UE 404c to retransmit X3(t) 412 to the base station 402 or for the relay node 406 to retransmit these signals to the base station 402.

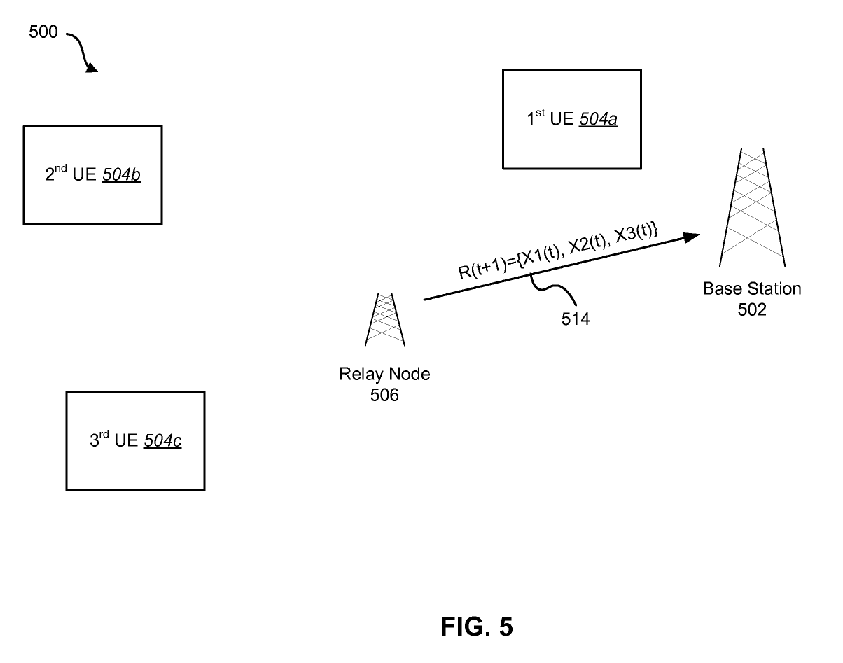

FIG. 5 is a block diagram illustrating a wireless communication system 500 with multiple UEs 504, a relay node 506, and a base station 502 during a second transmission at time t+1. The relay node 506 has correctly received the UE 504 transmitted signals X1(t), X2(t), and X3(t) 514 from the respective UEs 504. The relay node 506 may then indiscriminately retransmit each of the received signals. Thus, the relay station may retransmit X1(t), X2(t), and X3(t) 514 to the base station 502. At the end of time t+1, the base station has successfully received X1(t), X2(t), and X3(t) 514.

Oftentimes, it is unnecessary to retransmit the signals from a UE 504 or a set of UEs 504. By adding the functionality of selective relaying to the relay node 506, unnecessary retransmission can be prevented. The salvaged resources can then be used for the transmission of useful information. This may increase the efficiency of the wireless communication system 500.

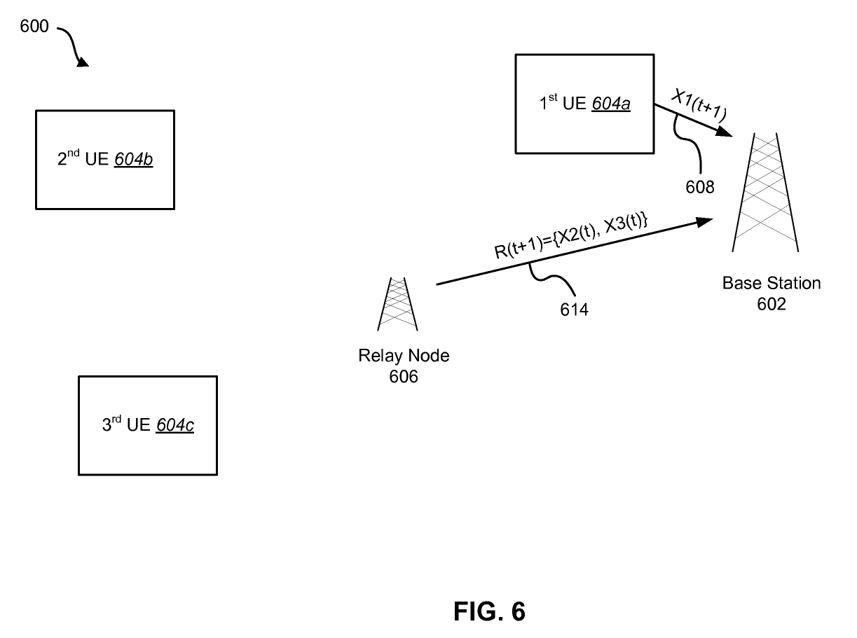

FIG. 6 is a block diagram illustrating a wireless communication system 600 with multiple UEs 604, a relay node 606, and a base station 602 during a second transmission at time t+1. The configuration in FIG. 6 operates differently than that of FIG. 5 in that the relay node 606 does not transmit all of the signals to the base station 602, but only transmits some of the signals to the base station 602. Because the 1^{st} UE 604a was either close enough to the base station 602 or the UE-base station channel quality 210 was sufficient, the base station 602 has already correctly received X1(t) 408a (See FIG. 4). By applying selective relaying, the relay node 606 may only transmit X2(t) and X3(t) 614 to the base station 602. This may allow the 1^{st} UE 604a to transmit new data X1(t+1) 608 to the base station 602 during the second transmission time. At the end of time t+1, the base station 602 has successfully received X1(t) 408a, X1(t+1) 608, X2(t), and X3(t) 614. By using a selective relaying scheme, the wireless communication system 600 has increased in efficiency.

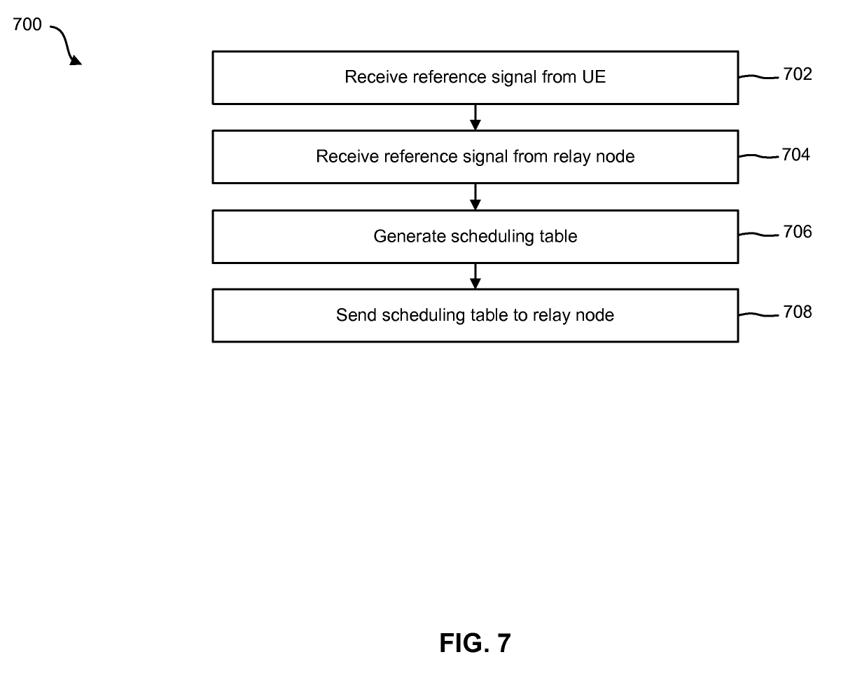

FIG. 7 is a flow diagram illustrating a scheduling table method 700 for selective relaying. A base station 102 may receive 702 a reference signal from a UE 104 or some other uniquely identifying signal from a UE 104. The UE 104 may be either sending a signal to the base station 102 or be the intended recipient of a signal sent from the base station 102. The base station 102 may also receive 704 a reference signal or some other uniquely identifying signal from a relay node 106. As discussed above in relation to FIG. 2, the base station 102 may alternatively receive a measurement of channel quality from the relay node 106. The base station 102 may use the reference signals to generate 706 a scheduling table 206. The scheduling table 206 may instruct a relay node 106 concerning the retransmission of signals. The base station 102 may then send 708 the scheduling table 206 to the relay node 106.

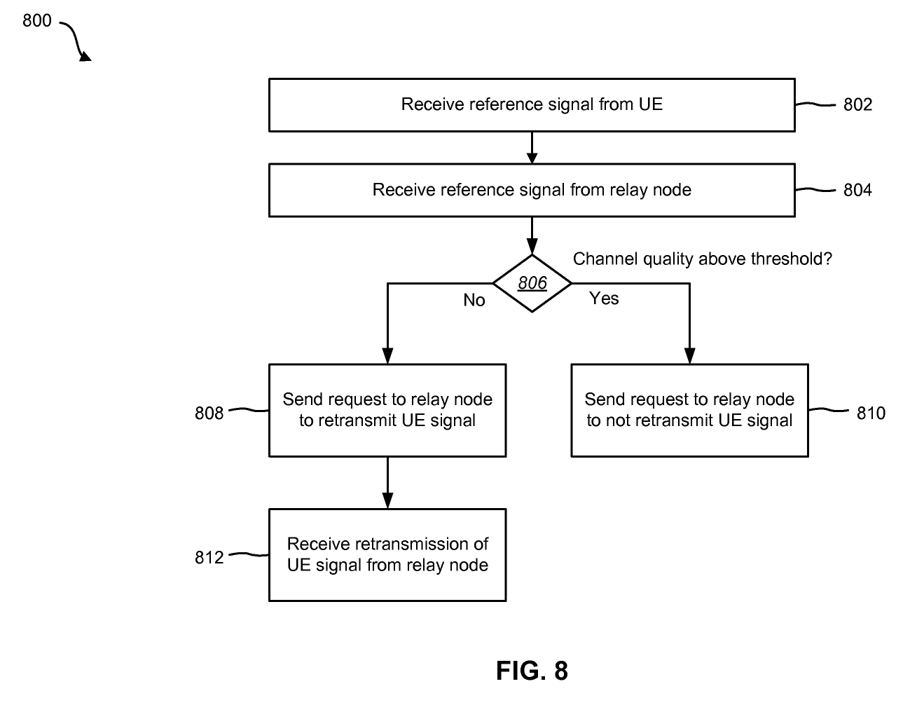

FIG. 8 is a flow diagram illustrating a threshold method 800 for selective relaying. A base station 102 may receive 802 a reference signal from a UE 104. As discussed above, the UE 104 may either be the sender of a signal to the base station 102 or the intended recipient of a signal being sent from the base station 102. The base station 102 may also receive 804 a reference signal from a relay node 106. The base station 102 may use the reference signals to determine the UE-base station channel quality 210, the UE-relay node channel quality 212, and the relay node-base station channel quality 328. The base station 102 may then determine 806 whether the UE-base station channel quality 210 is above a threshold 218. If the UE-base station channel quality 210 is above a threshold 218, there may be no need for a relay. The base station 102 may send 810 a request to the relay node 106 to not retransmit the signal from the UE 104. If the UE-base station channel quality 210 is not above the threshold 218, the base station 102 may send 808 a request to the relay node 106 to retransmit the signal from the UE 104. The base station 102 may then receive 812 the retransmission of the UE signal from the relay node 106.

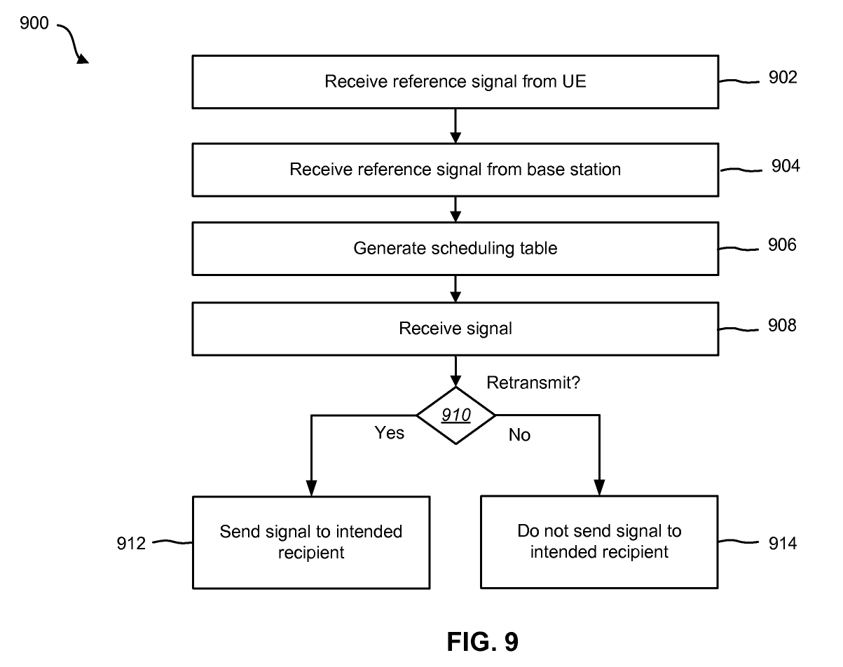

FIG. 9 is a flow diagram illustrating an additional scheduling table method 900 for selective relaying. A relay node 106 may receive 902 a reference signal from a UE 104. The relay node 106 may also receive 904 a reference signal from the base station 102. The relay node 106 may generate 906 a scheduling table 206 using the received reference signals. The relay node 106 may then receive 908 a signal. As discussed above, the signal may be received from a UE 104 or from a base station 102 and have an intended recipient. The relay node 106 may then determine 910 whether to retransmit the received signal. This determination 910 may be made using the generated scheduling table 206. If the relay node 106 determines to retransmit the signal, the relay node 106 may send 912 the signal to the intended recipient. If the relay node 914 determines to not retransmit the signal, the relay node 106 may not send 914 the signal to the intended recipient.

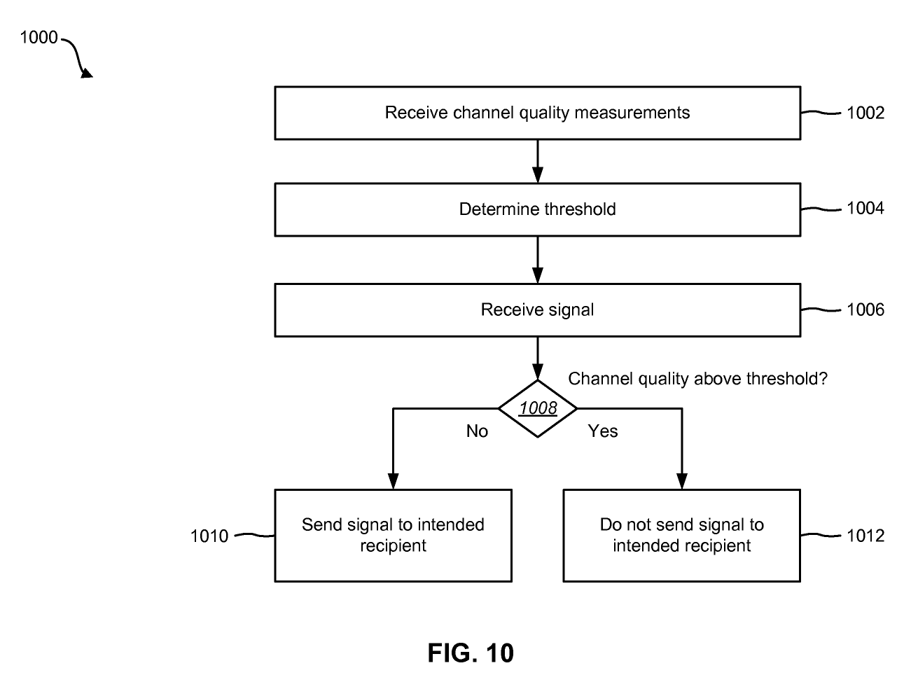

FIG. 10 is a flow diagram illustrating an additional threshold method 1000 for selective relaying. A relay node 106 may receive 1002 channel quality measurements from a UE 104 and a base station 102 that are attempting to communicate with each other. The relay node 106 may determine 1004 the threshold using the channel quality measurements. The relay node 106 may need to know the transmission parameters such as the transmission power and transmission rate in order to calculate the threshold 218 or find the appropriate threshold 218 from a look-up table.

The relay node 106 may then receive 1006 a signal. The signal may be received from either the UE 104 or the base station 102. The signal may have an intended recipient. The relay node 106 may determine 1008 whether the channel quality characteristics for the received signal are above the threshold 218. If the channel quality characteristics for the received signal are not above the threshold 218, the relay node 106 may send 1010 the received signal to the intended recipient. If the channel quality characteristics for the received signal are above the threshold 218, the relay node 106 may not send 1012 the received signal to the intended recipient.

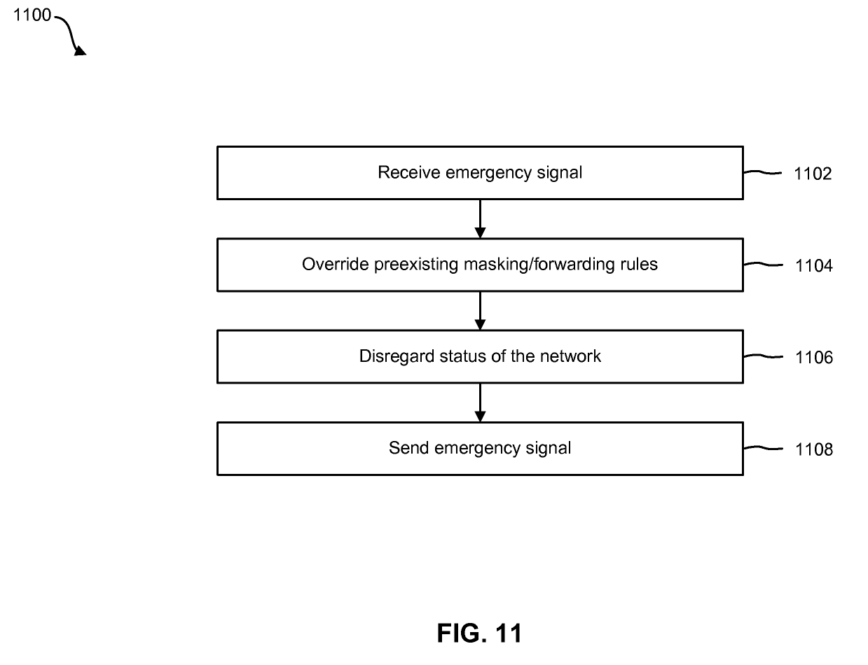

FIG. 11 is a flow diagram illustrating a method 1100 for selective relaying of an emergency signal. A relay node 106 may receive 1102 an emergency signal. The emergency signal may be received from a UE 104 or from a base station 102. The emergency signal may be, but is not limited to, a 911 call or other reserved emergency number, a reserved emergency message, or a UE stress signal. Upon receiving the emergency signal, the relay node 106 may override 1104 any preexisting masking and/or forwarding rules. The relay node 106 may also disregard 1106 the status of the network. The relay node 106 may send 1108 the emergency signal to the intended recipient.

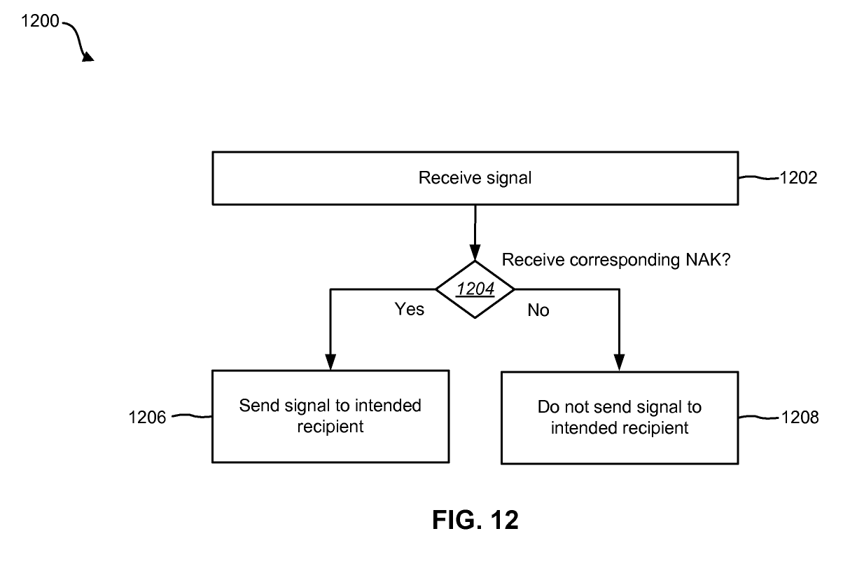

FIG. 12 is a flow diagram illustrating a method 1200 for signal triggered selective relaying. The relay node 106 may receive 1202 a signal. The received signal may be received from a UE 104 or from a base station 102. The relay node 106 may then determine 1204 whether a corresponding negative acknowledgment (NAK) 320 has been received. If a corresponding NAK 320 has been received, the relay node 106 may then send 1206 the signal to the intended recipient. If a corresponding NAK 320 has not been received, the relay node 106 may not send 1208 the signal to the intended recipient.

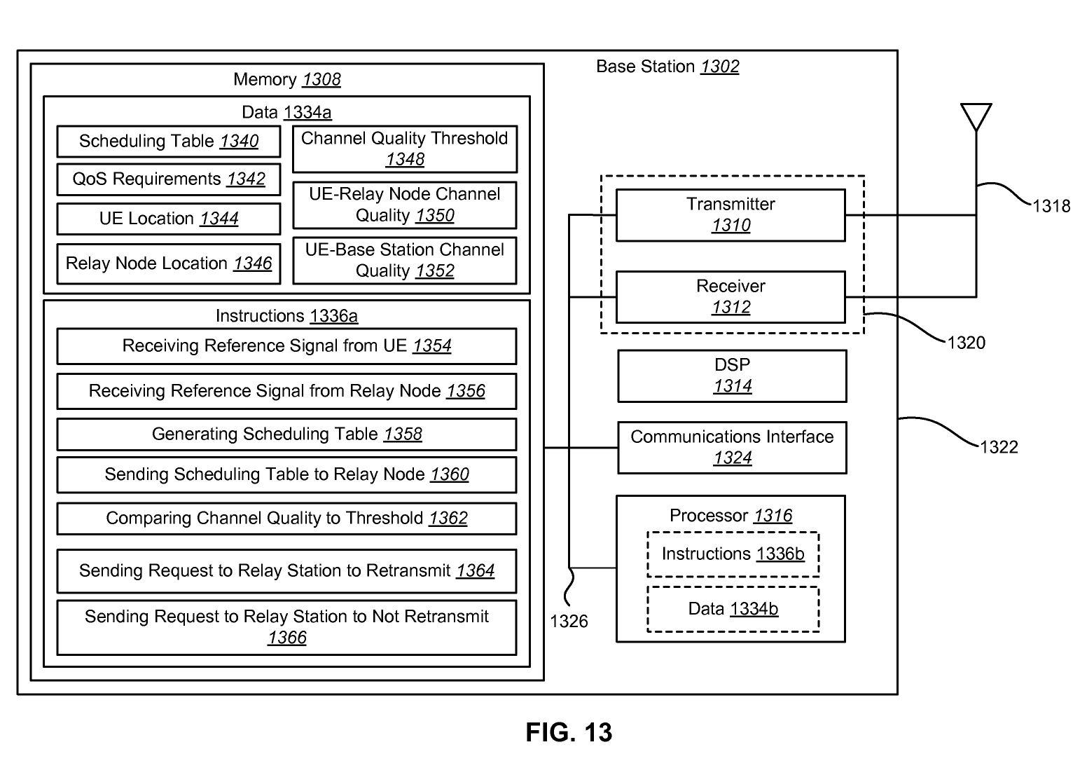

FIG. 13 is a block diagram of a base station 1302 in accordance with one configuration of the described systems and methods. The base station 1302 may be an evolved node B (eNB), a base station controller, a base station transceiver, etc. The base station 1302 may include a transceiver 1320 that includes a transmitter 1310 and a receiver 1312. The transceiver 1320 may be coupled to one or more antennas 1318. The base station 1302 may further include a digital signal processor (DSP) 1314, a general purpose processor 1316, memory 1308, and a communications interface 1324. The various components of the base station 1302 may be included within a housing 1322.

The processor 1316 may control operation of the base station 1302. The processor 1316 may also be referred to as a CPU. The memory 1308, which may include both read-only memory (ROM) and random access memory (RAM), provides instructions 1336a and data 1334a to the processor 1316. A portion of the memory 1308 may also include non-volatile random access memory (NVRAM). The memory 1308 may include any electronic component capable of storing electronic information, and may be embodied as ROM, RAM, magnetic disk storage media, optical storage media, flash memory, on-board memory included with the processor 1316, EPROM memory, EEPROM memory, registers, a hard disk, a removable disk, a CD-ROM, etc.

The memory 1308 may store program instructions 1336a and other types of data 1334a. For example, the memory 1302 may store program instructions 1336a such as instructions for receiving a reference signal from a UE 1354, instructions for receiving a reference signal from a relay node 1356, instructions for generating a scheduling table 1358, and instructions for sending a scheduling table to a relay node 1360. The program instructions 1336a may also include instructions for comparing the channel quality to a threshold 1362, instructions for sending a request to a relay station to retransmit data 1364, and instructions for sending a request to a relay station to not retransmit data 1366. The memory 1308 may store additional instructions 1336a not listed above.

The memory 1308 may store other types of data 1334a such as a scheduling table 1340, quality of service (QoS) requirements 1342, the UE location 1344, the relay node location 1346, the channel quality threshold 1348, the UE-relay node channel quality 1350, and the UE-base station channel quality 1352. The memory 1308 may store additional data 1334a not listed above.

The program instructions 1336a may be executed by the processor 1316 to implement some or all of the methods disclosed herein. The processor 1316 may also use the data 1334a stored in the memory 1308 to implement some or all of the methods disclosed herein. As a result, instructions 1336b and data 1334b may be loaded and/or otherwise used by the processor 1316.

In accordance with the disclosed systems and methods, the antenna 1318 may receive reverse link signals that have been transmitted from a nearby communications device, such as a UE 104 or a relay node 106. The antenna 1318 provides these received signals to the transceiver 1320 which filters and amplifies the signals. The signals are provided from the transceiver 1320 to the DSP 1314 and to the general purpose processor 1316 for demodulation, decoding, further filtering, etc.

The various components of the base station 1302 are coupled together by a bus system 1326 which may include a power bus, a control signal bus, and a status signal bus in addition to a data bus. However, for the sake of clarity, the various busses are illustrated in FIG. 13 as the bus system 1326.

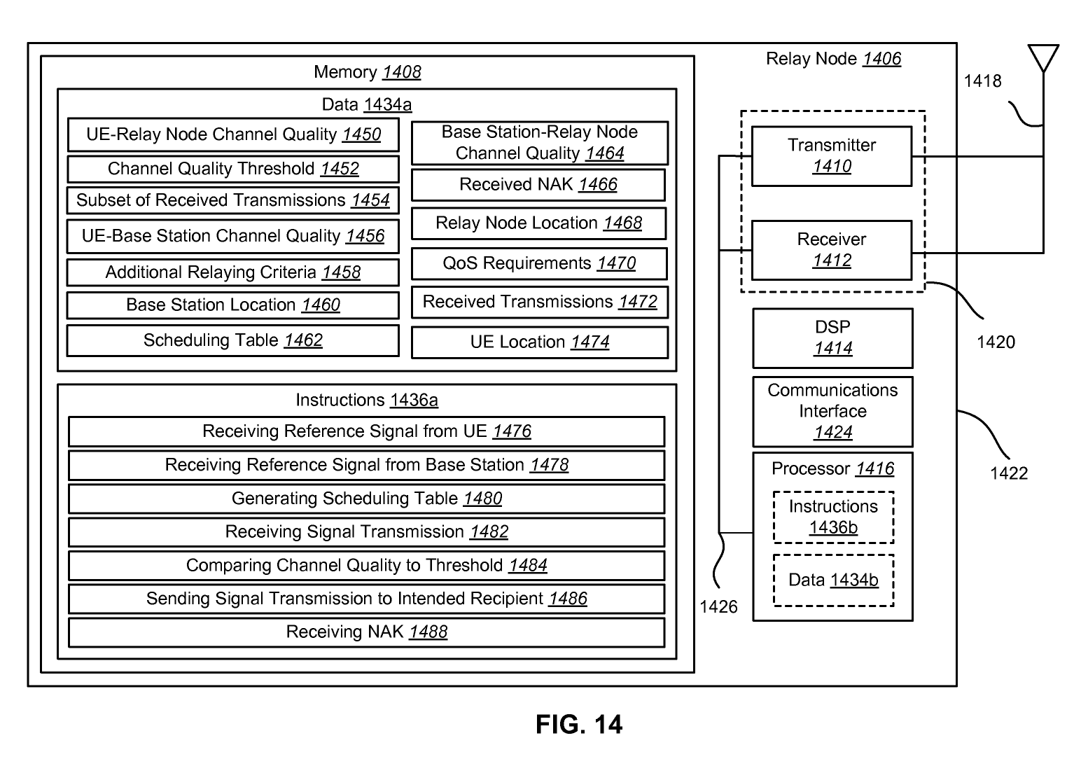

FIG. 14 is a block diagram of a relay node 1406 in accordance with one configuration of the described systems and methods. The relay node 1406 may be a repeater, a regenerative relay, an intermediate relay node, etc. The relay node 1406 may include a transceiver 1420 that includes a transmitter 1410 and a receiver 1412. The transceiver 1420 may be coupled to one or more antennas 1418. The relay node 1406 may further include a digital signal processor (DSP) 1414, a general purpose processor 1416, memory 1408, and a communications interface 1424. The various components of the relay node 1406 may be included within a housing 1422.

The processor 1416 may control operation of the relay node 1406. The processor 1416 may also be referred to as a CPU. The memory 1408, which may include both read-only memory (ROM) and random access memory (RAM), provides instructions 1436a and data 1434a to the processor 1416. A portion of the memory 1408 may also include non-volatile random access memory (NVRAM). The memory 1408 may include any electronic component capable of storing electronic information, and may be embodied as ROM, RAM, magnetic disk storage media, optical storage media, flash memory, on-board memory included with the processor 1416, EPROM memory, EEPROM memory, registers, a hard disk, a removable disk, a CD-ROM, etc.

The memory 1408 may store program instructions 1436a and other types of data 1434a. For example, the memory 1406 may store program instructions 1436a such as instructions for receiving a reference signal from a UE 1476, instructions for receiving a reference signal from a base station 1478, instructions for generating a scheduling table 1480, instructions for receiving a signal transmission 1482, instructions for comparing the channel quality to a threshold 1484, instructions for sending a signal transmission to the intended recipient 1486, and instructions for receiving a negative acknowledgment (NAK) 1488. The memory 1408 may store additional instructions 1436a not listed above.

The memory 1408 may store other types of data 1434a such as the UE-relay node channel quality 1450, the channel quality threshold 1452, the subset of received transmissions 1454, the UE-base station channel quality 1456, additional relaying criteria 1458, the base station location 1460, the scheduling table 1462, the base station-relay node channel quality 1464, a received NAK 1466, the relay node location 1468, the QoS requirements 1470, the received transmissions 1472, and the UE location 1474. The memory 1406 may store additional data 1434a not listed above.

The program instructions 1436a may be executed by the processor 1416 to implement some or all of the methods disclosed herein. The processor 1416 may also use the data 1434a stored in the memory 1408 to implement some or all of the methods disclosed herein. As a result, instructions 1436b and data 1434b may be loaded and/or otherwise used by the processor 1416.

In accordance with the disclosed systems and methods, the antenna 1418 may receive reverse link signals that have been transmitted from a nearby communications device, such as a UE 104 and forward link signals that have been transmitted from a nearby base station 102. The antenna 1418 provides these received signals to the transceiver 1420 which filters and amplifies the signals. The signals are provided from the transceiver 1420 to the DSP 1414 and to the general purpose processor 1416 for demodulation, decoding, further filtering, etc.

The various components of the relay node 1406 are coupled together by a bus system 1426 which may include a power bus, a control signal bus, and a status signal bus in addition to a data bus. However, for the sake of clarity, the various busses are illustrated in FIG. 14 as the bus system 1426.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for selective transmission by a relay node in a wireless communications system, the method comprising:
receiving a signal;
receiving channel quality information;
determining a threshold value;
comparing the channel quality information to the threshold value; and
transmitting the signal if the channel quality information is above the threshold value.

2. The method of claim 1, wherein the channel quality information is based on a reference signal from a user equipment (UE).

3. The method of claim 1, wherein the channel quality information is based on a reference signal from a base station.

4. The method of claim 1, further comprising generating a scheduling table using the channel quality information.

5. The method of claim 1, further comprising receiving a scheduling table from a base station.

6. The method of claim 1, further comprising automatically transmitting the signal if the signal is an emergency signal.

7. The method of claim 5, wherein automatically transmitting the signal comprises overriding preexisting masking/forwarding rules and disregarding the status of the network.

8. The method of claim 1, further comprising transmitting the signal if the relay node receives a negative acknowledgment (NAK) corresponding to the signal from the base station.

9. The method of claim 1, further comprising retransmitting the signal if the relay node receives a negative acknowledgment (NAK) corresponding to the signal from the UE.

10. The method of claim 1, wherein the method is implemented in a wireless communication system that supports an Institute of Electrical and Electronics Engineers (IEEE) 802.16 standard.

11. A relay node for selective transmission in a wireless communications system, the relay node comprising:
a processor;
memory in electronic communication with the processor;
instructions stored in the memory, the instructions being executable to:
receive a signal;
receive channel quality information;
determine a threshold value;
compare the channel quality information to the threshold value; and
transmit the signal if the channel quality information is above the threshold value.

12. The relay node of claim 11, wherein the channel quality information is based on a reference signal from a user equipment (UE).

13. The relay node of claim 11, wherein the channel quality information is based on a reference signal from a base station.

14. The relay node of claim 11, wherein the instructions are further executable to generate a scheduling table using the channel quality information.

15. The relay node of claim 11, wherein the instructions are further executable to receive a scheduling table from a base station.

16. The relay node of claim 11, wherein the instructions are further executable to automatically transmit the signal if the signal is an emergency signal.

17. The relay node of claim 15, wherein automatically transmitting the signal comprises overriding preexisting masking/forwarding rules and disregarding the status of the network.

18. The relay node of claim 11, wherein the instructions are further executable to transmit the signal if the relay node receives a negative acknowledgment (NAK) corresponding to the signal.

19. The relay node of claim 11, wherein the relay node supports an Institute of Electrical and Electronics Engineers (IEEE) 802.16 standard.

20. A base station for directing a relay node regarding selective transmission in a wireless communications system, the base station comprising:
a processor;
memory in electronic communication with the processor;
instructions stored in the memory, the instructions being executable to:
determine channel quality information for multiple channels;
transmit instructions to a relay node to transmit certain signals the relay node has received; and
transmit instructions to a relay node not to transmit other signals the relay node has received, wherein not all signals received by the relay node are transmitted by the relay node.

21. The base station of claim 20, wherein the instructions are further executable to generate a scheduling table using the channel quality information.

22. The base station of claim 21, wherein the instructions are further executable to transmit the scheduling table to the relay node.

23. A computer-readable medium comprising executable instructions for:
receiving a signal;
receiving channel quality information;
determining a threshold value;
comparing the channel quality information to the threshold value; and
transmitting the signal if the channel quality information is above the threshold value.

24. The method of claim 1, wherein the signal is being received on an uplink.

25. The method of claim 1, wherein the signal is being received on a downlink.

26. The relay node of claim 11, wherein the signal is being received on an uplink.

27. The relay node of claim 11, wherein the signal is being received on a downlink.

28. A method for selective transmission by a relay node in a wireless communications system, the method comprising:
receiving a signal; and
transmitting the signal if the relay node receives a negative acknowledgment (NAK) corresponding to the signal.

29. The method of claim 28, wherein the signal is being received on an uplink.

30. The method of claim 28, wherein the signal is being received on a downlink.

31. A relay node for selective transmission in a wireless communications system, the relay node comprising:
a processor;
memory in electronic communication with the processor;
instructions stored in the memory, the instructions being executable to:
receive a signal;
transmit the signal if the relay node receives a negative acknowledgment (NAK) corresponding to the signal.

32. The relay node of claim 31, wherein the signal is being received on an uplink.

33. The relay node of claim 31, wherein the signal is being received on a downlink.
